(19) United States
(12) Patent Application Publication
(10) Pub. No.: US 2018/0099810 A1
(43) Pub. Date: Apr. 12, 2018

(54) ROBOTS FOR TRANSPORTING INVENTORY HOLDER

(71) Applicant: Zhejiang Guozi Road Robot Technology Co., Ltd., Zhejiang (CN)

(72) Inventors: Weifeng WU, Zhejiang (CN); Wangdong WU, Zhejiang (CN); Chengkang RAO, Zhejiang (CN); Zhenhua Shen, Zhejiang (CN); Yikun TAO, Zhejiang (CN); Lingfen ZHU, Zhejiang (CN); Xia WANG, Zhejiang (CN); Hongbo ZHENG, Zhejiang (CN); Xinfeng DU, Zhejiang (CN)

(21) Appl. No.: 15/305,165

(22) PCT Filed: Oct. 8, 2016
(86) PCT No.: PCT/CN2016/101507

§ 371 Date: Oct. 19, 2016

(51) Int. Cl. B65G 1/04; B25J 5/00; B66F 3/08

(52) U.S. Cl. CPC B65G 1/0492; Y10S 901/01; B66F 3/08; B25J 5/007

(57) ABSTRACT

The present invention discloses a robot for transporting inventory holders, comprising a chassis, a drive unit, a follow unit and a lift unit. The lift unit comprises a fixing frame, a pallet, a lower connecting plate, a sliding module, a guided screw, a guided screw nut, a motor, an actuating mechanism, a position-limit module, and a positioning module. The fixing frame, the pallet and the lower connecting plate are each provided with an opening, and the three openings are coaxial and mutually communicated. The positioning module is removably disposed inside the through holes, and the guided screw is disposed on the side edge of the fixing frame, avoiding the positioning module. The robot for transporting inventory holders according to the present invention has the advantages of simple structures and lower costs.

### FIELD OF THE INVENTION

The present invention relates to the field of auxiliary devices for warehousing and logistics, and more particularly, to a robot for transporting inventory holders.

### DESCRIPTION OF THE PRIOR ART

A transporting robot is a device applied to automated materials transporting, having a lot of benefits, such as high automaticity, flexible applications, safety reliability, high efficiency and convenient repair and maintenance, and the like, which makes the unmanned transporting robots a key equipment in modern logistics systems and become one of the important members in the program “machine substitution for human labor”.

The transporting robot finds its broad applications in the field of logistics and transportation in auto manufacturing industries, food industries, tobacco industries, engineering and machinery industries and the like. In addition, they are also widely applied in various public service places such as airdromes, hospitals and ottice buildings.

The inventory holder transporting robot generally has a function of rotating in situ, and due to positioning needs, the places where their rotation axes are located are established to be hollow for mounting positioning module, and, therefore, the conventional lifting method cannot be adopted. Some patents have proposed using the hollow guided screw to perform lifting, but the hollow guided screw have high costs of manufacturing, which are disadvantageous to applications in large scales.

### SUMMARY OF THE INVENTION

In view of the foregoing problems, an object of the present invention is to provide a transporting robot that is structurally simple and has lower cost.

In order to achieve these technical goals, the present invention provides a robot for transporting inventory holders, comprising a chassis, a drive unit, a follow unit and a lift unit. The drive unit is disposed on the chassis, and the drive unit causes the chassis to be away from the ground, the distances that the chassis is away from the ground is limited by the disposed position of the drive unit. The follow unit is disposed on the edge of the chassis and on a position different from the position of the drive unit. The lift unit is disposed on the chassis, and the lift unit is disposed between two drive units, the follow unit and the drive unit located on one same plane, the follow unit and the drive unit collectively supporting the chassis, the follow unit and the drive unit causing the chassis and the ground to remain parallel.

Furthermore, the center line of the lifting direction of the lift unit perpendicularly intersects with the axis of rotation of a drive wheel.

Furthermore, the lift unit comprises a fixing frame, a pallet, a lower connecting plate, a sliding module, a guided screw, a guided screw nut, a motor, an actuating mechanism, a position-limit module, and a positioning module; the fixing frame, the pallet and the lower connecting plate are each provided an opening in the middle, and the opening in the middle of the fixing frame, the opening in the middle of the pallet and the opening in the middle of the lower connecting plate are mutually communicated. The positioning module is divided into an upward part and a downward part.

Furthermore, the opening in the middle of the fixing frame, the opening in the middle of the pallet and the opening in the middle of the lower connecting plate are coaxial.

Furthermore, the guided screw is disposed on a side edge of the fixing frame, avoiding the positioning module. The guided screw is connected to the motor through the actuating mechanism, and the guided screw nut matches with the guided screw through the lower connecting plate.

Furthermore, a fixed end of the sliding module is mounted to the fixing frame, a first end of the sliding end of the sliding module is connected to the pallet, and a second end of the sliding end of the sliding module is connected to the lower connecting plate. The position-limit module is disposed on the side edge of the fixing frame.

Furthermore, the drive units are symmetrically disposed on the outer side of the chassis, and the drive units are provided symmetrical about the midline of the chassis as an axis. The drive unit comprises the drive wheel and a drive box, and the drive wheel is connected to the drive box through a wheel shaft. The axes of rotation of the drive wheels on both sides are collinear, and the drive box contains a power system inside thereof. The power system drives the drive wheel to move forwardly or reversely through the wheel shaft.

Furthermore, the follow unit is a casterwheel, and the number of the follow unit disposed on the chassis being at least two.

Furthermore, the sliding module is a combination of a guide rail and a slider or a combination of a linear bearing and a guide rod. The slide direction of the sliding module is conformed to the lifting direction of the pallet of the lift unit.

Furthermore, the transmission method of the actuating mechanism is a belt driven method or a gear driven method.

Furthermore, the position-limit module is a contact position-limit sensor or a non-contact position-limit sensor.

Furthermore, when the motor is running, the motor drives the guided screw to rotate through the actuating mechanism, the guided screw drives the lower connecting plate to move in the slide direction of the sliding module, and the lower connecting plate drives the pallet to move.

The robot for transporting inventory holders of the present invention adopts the hollow structures, offsets the guided screw on the side edge of the fixing frame, and is structurally simple; the guided screw used is a standard part, without using a hollow guided screw, molding and processing, and is commercially available directly in the markets, which effectively shorten the production cycles of robots and reduces the processing cost.

The method and the technical effects of the present invention will be further illustrated below in conjunction with the accompanying drawings, in order to fully understand the objects, features and effects of the present invention.

### BRIEF DESCRIPTION OF THE DRAWINGS

FIG. 1 is a three-dimensional structure diagram of the robot of a preferred embodiment of the present invention;

FIG. 2 is a side diagram of the lift unit of a preferred embodiment of the present invention;

FIG. 3 is a front diagram of the lift unit of a preferred embodiment of the present invention; in which,

1—chassis; 2—drive unit; 21—drive wheel; 22—drive box; 3—follow unit; 4—lift unit; 41—fixing frame; 42—pallet; 43—lower connecting plate; 44—sliding module; 451—guided screw; 452—guided screw nut; 46—motor; 47—actuating mechanism; 48—position-limit module; 49—positioning module.

### DETAILED DESCRIPTION OF THE PREFERRED EMBODIMENTS

The present invention will be explained in greater detail herein in conjunction with the accompanying drawings and specific embodiments.

### Embodiment 1

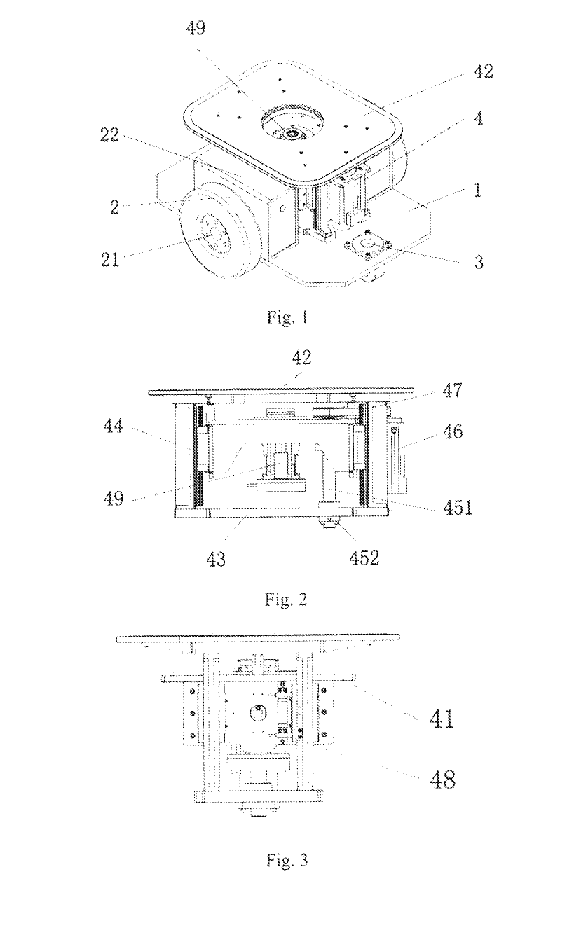

As shown in FIGS. 1 to 3, the present invention discloses a robot for transporting, comprising a chassis 1, a drive unit 2, a follow unit 3, and a lift unit 4. The drive units 2 are disposed on both sides of the chassis 1. The follow unit 3 is disposed in front and on the rear of the chassis 1. The lift unit 4 is disposed in the middle of the chassis 1, and is mounted on the drive unit 2 on both sides. The drive unit 2 and the follow unit 3 collectively support the chassis, and the follow unit 3 and the drive unit 2 cause the chassis and the ground to remain parallel. The drive units 2 on both sides are symmetrically arranged, and the axes of rotation of the drive wheels 21 thereof on both sides are collinear. The centerline of the lifting direction of the lift unit perpendicularly intersects with the axes of rotation of the drive wheels 21.

The lift unit 4 comprises a fixing frame 41, a pallet 42, a lower connecting plate 43, a sliding module 44, a guided screw 451, a guided screw nut 452, a motor 46, a actuating mechanism 47, a position-limit module 48, and a positioning module 49. The fixed end of the sliding module 4 is mounted to the fixing frame 41, a first end of the sliding end of the sliding module is connected to the pallet 42, and a second end of the sliding end of the sliding module is connected to the lower connecting plate 43. The fixing frame 41, the pallet 42 and the lower connecting plate 43 are each provided with an opening in the middle, and the opening in the middle of the fixing frame 41, the opening in the middle of the pallet 42 and the opening in the middle of the lower connecting plate 43 are mutually communicated for mounting a positioning module 49. The guided screw 451 is disposed on the side edge of the fixing frame 41, avoiding the positioning module 49.

The guided screw 451 is connected to the motor 46 through the actuating mechanism 47, and the guided screw nut 452 matches with the guided screw 451 through the lower connecting plate 43. The position-limit module 48 is disposed on the side edge of the fixing frame 41 for upper and lower position limiting of the lift unit 4 during lifting.

The drive units 2 on both sides are symmetrically disposed on the chassis, which are mirror symmetrical, with the midline of the chassis as an axis. The drive unit 2 comprises the drive wheel 21 and a drive box 22, and the drive wheel 21 is connected to the drive box 22 through the wheel shaft. The drive box 22 contains a power system inside thereof, which drives the drive wheel 21 to move forwardly or reversely through the wheel shaft.

The follow unit 3 is a casterwheel, the number of the follow unit 3 disposed on the chassis being two.

The sliding module 44 is a combination of a guide rail and a slider; the slide direction of the sliding module 44 is conformed to the lifting direction of the pallet 42 of the lift unit 4.

The actuating mechanism 47 is belt driven.

The position-limit module 48 is a contact position-limit sensor.

The positioning module 49 is divided into an upward part and a downward part, with the downward part being used for recognizing the positions and gesture information of the robots on the ground, an upward part being used for recognizing the positions and gesture information of the inventory holders.

On the upper end-face of the pallet 42 is disposed a rubber that is a material with large friction coefficient, facilitating robots for better lifting and transporting inventory holders.

The motor 46 drives the guided screw 451 to rotate through the actuating mechanism 47 during rotating, causing the lower connecting plate 43 together with the guided screw nut 452 placed on it to move in the slide direction of the sliding module 44. Since the pallet 42 is permanently connected to the lower connecting plate 43 through the sliding ends of the sliding module 44, the pallet 42 also moves together with the lower connecting plate 43. If the pallet moves upwards, the inventory holders are lifted, and if the pallet moves downwards, the inventory holders are dropped.

The present invention governs the drive unit 2 by the control system during transporting inventory holders, causing robots to walk to the places underneath the inventory holders, lifting the inventory holders by the lift unit 4; when it is necessary to rotate in situ during the transportation process, robots are caused to rotate in situ by controlling the drive unit 2 while the inventory holders synchronously rotating.

### Embodiment 2

As shown in FIGS. 1 to 3, the present invention discloses a robot for transporting, comprising a chassis 1, a drive unit 2, a follow unit 3, and a lift unit 4. The drive units 2 are disposed on the both sides of the chassis 1, and the follow units 3 are disposed in front and on the rear of the chassis 1. The drive unit 2 and the follow unit 3 collectively support the chassis, and the follow unit 3 and the drive unit 2 cause the chassis and the ground to remain parallel. The lift unit 4 is disposed in the middle of the chassis 1 and mounted on the drive units 2 on both sides. The drive units 2 on both sides are symmetrically arranged, the axes of rotation of the drive wheels 21 thereof on both sides are collinear. The centerline of the lifting direction of the lift unit perpendicularly intersects the axes of rotation of the drive wheels 21.

The lift unit 4 comprises a fixing frame 41, a pallet 42, a lower connecting plate 43, a sliding module 44, a guided screw 451, a guided screw nut 452, a motor 46, a actuating mechanism 47, a position-limit module 48, and a positioning module 49. The fixed end of the sliding module 4 is mounted to the fixing frame 41, a first end of the sliding end of the sliding module is connected to the pallet 42, and a second end of the sliding end of the sliding module is connected to the lower connecting plate 43. The fixing frame 41, the pallet 42 and the lower connecting plate 43 are each provided with an opening in the middle, and the opening in the middle of the fixing frame 41, the opening in the middle of the pallet 42 and the opening in the middle of the lower connecting plate 43 are coaxial, and are mutually communicated for mounting positioning module 49. The guided screw 451 is disposed on the side edge of the fixing frame 41, avoiding the positioning module 49, the guided screw 451 is connected to the motor 46 through the actuating mechanism 47, and the guided screw nut 452 matches with the guided screw 451 through the lower connecting plate 43. The position-limit module 48 is disposed on the side edge of the fixing frame 41 for upper and lower position limiting of the lift unit 4 while lifting.

The drive units 2 on both sides are symmetrically disposed on the chassis, which are symmetrical, with the midline of the chassis as an axis. The drive unit 2 comprises the drive wheel 21 and a drive box 22, and the drive wheel 21 is connected to the drive box 22 through the wheel shaft, the drive box 22 contains a power system inside thereof, which drives the drive wheel 21 to move forwardly or reversely through the wheel shaft.

The follow unit 3 is a casterwheel, the number of the follow unit disposed on the chassis being four.

The sliding module 44 is a combination of a linear bearing and a guide rod, the slide direction of the sliding module 44 is conformed to the lifting direction of the pallet 42 of the lift unit 4.

The actuating mechanism 47 uses the gear driven method.

The position-limit module 48 is a non-contact position-limit sensor.

The positioning module 49 is divided into an upward part and a downward part, with the downward part being used for recognizing the positions and gesture information of the robot on the ground, the upward part being used for recognizing the positions and gesture information of the inventory holders.

A rubber that is a material with large friction coefficient is disposed on the upper end-face of the pallet 42, facilitating the robot for better lifting and transporting inventory holders.

The motor 46 drives the guided screw 451 to rotate through the actuating mechanism 47 while it is rotating, causing the lower connecting plate 43 together with the guided screw nut 452 placed on it to move in the slide direction of the sliding module 44. Since the pallet 42 is permanently connected to the lower connecting plate 43 through the sliding ends of the sliding module 44, the pallet 42 also moves together with the lower connecting plate 43. If the pallet moves upwards, the inventory holders are lifted, and if the pallet moves downwards, the inventory holders are dropped.

The present invention governs the drive unit 2 by the control system during transporting inventory holders, causing robots to walk to the places underneath the inventory holders, lifting the inventory holders by the lift unit 4; when it is necessary to rotate in situ during the transportation process, the lift unit 4 drops the inventory holders first, and then causes robots to rotate in situ by the drive unit 2 until the required direction is reached, then the lift unit 4 lifts the inventory holders again, the gesture of the inventory holders remaining unchanged.

The foregoing descriptions are only the preferred embodiments of the present invention, and are not intended to limit the present invention. Any subtle modifications, equivalent replacements and improvements of the above embodiments according to the technical substance of the present invention are contained in the ranges of protection of the technical proposal of the present invention.

1. A robot for transporting inventory holders, wherein the robot for transporting inventory holders comprises a chassis, a drive unit, a follow unit and a lift unit;
the drive unit is disposed on the chassis, the drive unit causes the chassis to be away from the ground, and the distance that the chassis is away from the ground is limited by the disposed position of the drive unit;
the follow unit is disposed on the edge of the chassis and on a position different from the position of the drive unit;
the drive unit comprises two drive wheels;
the lift unit is disposed on the chassis, and the lift unit is disposed between the two drive wheels;
the follow unit and the drive unit are located on one same plane, the follow unit and the drive unit collectively supporting the chassis, the follow unit and the drive unit causing the chassis and the ground to remain parallel;
the lift unit comprises a fixing frame, a pallet, a lower connecting plate, a sliding module, a guided screw, a guided screw nut, a motor, an actuating mechanism, a position-limit module, a positioning module;
the fixing frame, the pallet and the lower connecting plate are each provided with an opening, and the opening in the middle of the fixing frame, the opening in the middle of the pallet and the opening in the middle of the lower connecting plate are mutually communicated;
the positioning module is divided into an upward part and a downward part;
the guided screw is disposed on a side edge of the fixing frame, avoiding the positioning module;
the guided screw is solid; and
the guided screw is connected to the motor through the actuating mechanism, and the guided screw nut matches with the guided screw through the lower connecting plate.

2. The robot for transporting inventory holders according to claim 1, wherein a center line of the lifting direction of the lift unit perpendicularly intersects with the axis of rotation of the drive wheels.

3. (canceled)

4. The robot for transporting inventory holders according to claim 1, wherein the opening in the middle of the fixing frame, the opening in the middle of the pallet and the opening in the middle of the lower connecting plate are coaxial.

5. (canceled)

6. The robot for transporting inventory holders according to claim 4, wherein a fixed end of the sliding module is mounted to the fixing frame, a first end of a sliding end of the sliding module is connected to the pallet, and a second end of the sliding end of the sliding module is connected to the lower connecting plate; the position-limit module is disposed on the side edge of the fixing frame.

7. The robot for transporting inventory holders according to claim 1, wherein the drive wheels are symmetrically disposed on the outer side of the chassis, and the drive wheels are provided symmetrical about the midline of the chassis as an axis, the drive unit further comprising a drive box, the drive wheels connected to the drive box through a wheel shaft, the axes of rotation of the drive wheels on both sides being collinear, the drive box containing a power system inside thereof, the power system driving the drive wheels to move forwardly or reversely through the wheel shaft.

8. The robot for transporting inventory holders according to claim 1, wherein the follow unit is a casterwheel, the number of the follow unit disposed on the chassis being at least two.

9. The robot for transporting inventory holders according to claim 1, wherein the sliding module is a combination of a guide rail and a slider or a combination of a linear bearing and a guide rod; the slide direction of the sliding module is conformed to the lifting direction of the pallet of the lift unit.

10. The robot for transporting inventory holders according to claim 1, wherein when the motor is running, the motor drives the guided screw to rotate through the actuating mechanism, the guided screw drives the lower connecting plate to move in the slide direction of the sliding module, the lower connecting plate driving the pallet to move.
